(19) United States
(12) Patent Application Publication
(10) Pub. No.: US 2003/0025438 A1
(43) Pub. Date: Feb. 6, 2003

(54) Cathode ray tube and display apparatus

(76) Inventors: Reo Asaki, Tokyo (JP); Mitsuo Hashimoto, Kanagawa (JP); Masataka Santoku, Kanagawa (JP); Masamichi Okada, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/180,487

(22) Filed: Jun. 27, 2002

(30) Foreign Application Priority Data
Jun. 27, 2001 (JP) P2001-193875

(51) Int. Cl. H01J 31/00

(52) U.S. Cl. 313/477 R

(57) ABSTRACT

A cathode ray tube is disclosed wherein the stress at a bonding portion between a glass member and a metal member is moderated. The cathode ray tube includes a panel made of glass, a skirt element made of metal and attached to a peripheral edge of the panel, and a funnel connected to the skirt element. The skirt element has a rib or ribs for reinforcement provided thereon. The cathode ray tube may be incorporated in a display apparatus.

### BACKGROUND OF THE INVENTION

This invention relates to a cathode ray tube wherein metal is used for a vacuum vessel and a display apparatus which uses the cathode ray tube.

A vacuum tube which composes a cathode ray tube is normally made of glass and has a structure that two members including a panel serving as a display screen section and a funnel are bonded to each other with frit glass.

The inside of the vessel is kept in a vacuum state and the glass vessel is normally acted upon by a pressure of 1 atm. Therefore, in order that the glass vessel which composes a cathode ray tube may satisfy characteristics as a vacuum vessel, it is demanded for the glass vessel to satisfy necessary performances with regard to the vacuum withstanding property and the explosion-proof characteristic.

In addition to the vacuum withstanding property and the explosion-proof characteristic, such characteristics as a bonding property between the panel and the funnel, a heat resisting property and a vacuum keeping property are required for the vacuum vessel of a cathode ray tube. Glass which can satisfy such performances is usually used for both of the panel and the funnel.

Usually, in order for a vacuum vessel made of glass to realize such performances as described above, a method of using a glass plate of a great thickness to secure the strength is used. In other words, in order to raise the strength of a glass bulb, it is necessary to increase the thickness of the glass. Increase of the glass thickness is advantageous also for the explosion-proof characteristic.

In recent years, increase of the screen size of a television set has proceeded, and it has been a problem that such increase of the screen size increases the glass thickness in order to secure the strength of the vacuum vessel, resulting in increase of the weight of the cathode ray tube. Further, as a result of employment of a screen of a flattened configuration in recent years, the vacuum vessel uses an increased glass thickness when compared with that of a conventional rounded cathode ray tube in order to secure the vacuum withstanding property and the explosion-proof characteristic thereof, and this is a factor of increase of the weight.

For example, in the vacuum vessel for a television set of the 36-inch type, the total weight of the glass of the panel and the funnel is 50 kg or more. Further increase of the cathode ray tube further increases the glass weight, and actually it is difficult to form a cathode ray tube of such an increased weight.

From the point of view of energy saving, reduction of the cost and so forth, examination for reduction of the weight of glass is proceeding in order to solve the problem of the increase of the weight by increase of the screen size of the color cathode ray tube. The examination is directed to augmentation of the mechanical strength of glass by a reinforcement technique to decrease the glass thickness to reduce the glass weight.

As another approach, a method of forming a panel skirt part other than a display section of a front face with which the optical characteristic does not matter and a funnel part from a metal material having a high specific strength to achieve reduction of the weight has been proposed.

This method, however, has problems in security of the strength of a metal member when the vacuum vessel is formed from a thin metal plate and the bonding strength between the glass panel and the metal member, and it is difficult to realize the method particularly with a cathode ray tube of a large size which requires a high strength. A cathode ray tube is proposed in Japanese Patent Publication No. Hei 7-40474 which employs a funnel made of metal to which a rib is attached to reinforce the funnel. However, no proposal has been made for a countermeasure for reducing the stress of the panel glass and the metal with regard to a particular shape of the rib or the position at which the rib is to be attached. Further, since the flat glass panel and the metal funnel are connected directly to each other, it is difficult to attach a color selection mechanism upon formation of stripes of a fluorescent material, and therefore, a novel production method quite different from existing methods is required.

### SUMMARY OF THE INVENTION

It is an object of the present invention to provide a cathode ray tube wherein the stress at a bonding portion between a glass member and a metal member is moderated.

In order to attain the object described above, according to the present invention, there is provided a cathode ray tube including a panel made of glass, a skirt element made of metal and attached to a peripheral edge of the panel, and a funnel connected to the skirt element, the skirt element having a rib or ribs for reinforcement provided thereon. The cathode ray tube may be incorporated in a display apparatus.

In the cathode ray tube, since a rib or ribs are provided on the skirt element made of metal and interposed between the panel made of glass and the funnel, the metal skirt element is reinforced by the rib or ribs. Thus, the stress at the bonding portion between the panel and the skirt element to which the stress is applied highest when the cathode ray tube is placed into a vacuum state can be moderated.

With the cathode ray tube, reduction of the stress at the bonding portion between the panel and the skirt element, that is, between the glass and the metal, can be achieved, and consequently, augmentation of the strength and augmentation of the damage resisting property of the cathode ray tube as a vacuum vessel can be achieved. Accordingly, reduction of the weight of a display apparatus which employs the cathode ray tube can be achieved effectively.

### BRIEF DESCRIPTION OF THE DRAWINGS

These and other objects of the invention will be seen by reference to the description, taken in connection with the accompanying drawing, in which:

FIG. 1 is a schematic view showing a cathode ray tube to which the present invention is applied;

FIG. 2 is a partial enlarged perspective view of the cathode ray tube of FIG. 1;

FIG. 3 is a schematic sectional view of a cathode ray tube wherein a metal is used for a funnel;

FIG. 4 is a schematic perspective view showing a three-dimensional vacuum vessel model applied in a three-dimensional stress analysis together with particular dimensions;

FIG. 5 is an enlarged schematic sectional view illustrating dimensions of a bonding portion of the three-dimensional vacuum vessel model of FIG. 4;

FIG. 6 is an enlarged schematic sectional view showing a three-dimensional vacuum vessel model having a rib; and

FIG. 7 is a table illustrating rib conditions and results of a stress analysis with regard to various examples.

### DETAILED DESCRIPTION OF THE PREFERRED EMBODIMENT

In the following, the present invention is de scribed in detail in connection with a preferred embodiment shown in the accompanying drawings. In the cathode ray tubes of the embodiment of the present invention, a quantitative analysis has been performed through three-dimensional stress analysis calculation in order to propose a shape and an attached position of a rib which effectively achieve reduction of the stress at a glass/metal bonding portion which most matters with a vacuum vessel formed using glass and metal.

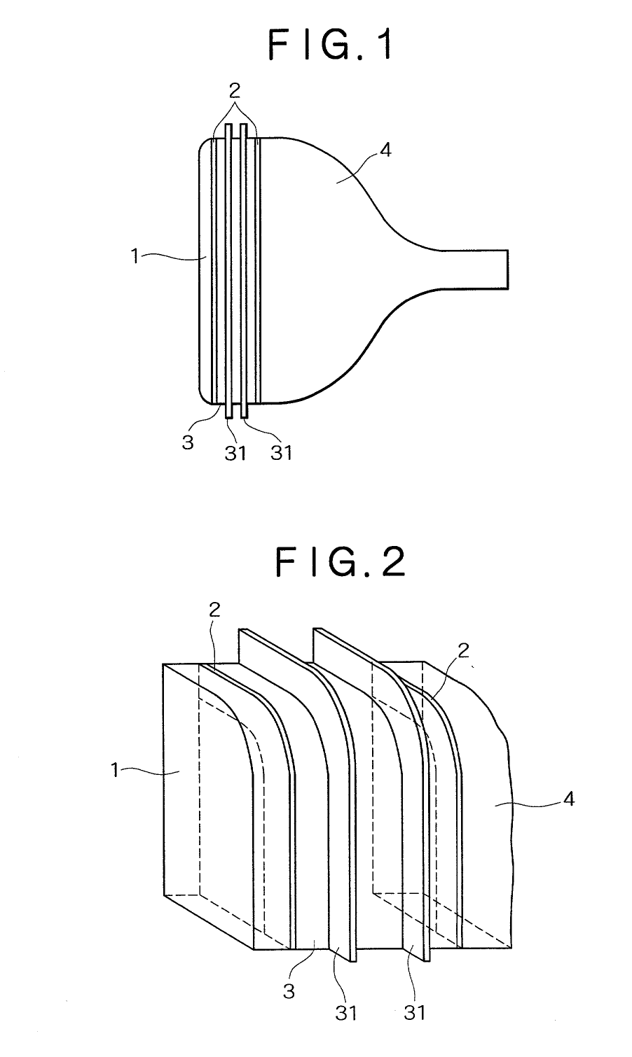

Referring first to FIGS. 1 and 2, there is shown a schematic view showing a cathode ray tube to which the present invention is applied in FIG. 1 and a partial enlarged perspective view of the cathode ray tube of FIG. 1 in FIG. 2. The cathode ray tube includes a vacuum vessel composed of a panel 1 made of glass and serving as a front display screen, a skirt part 3 made of metal and attached to a peripheral edge of the panel 1, and a funnel 4 connected to the skirt part 3.

A funnel made of glass or metal can be applied as the funnel 4 of the rear part. The panel 1 and the skirt part 3 are connected to each other and the skirt part 3 and the funnel 4 are connected to each other using frit glass 2. A material having a low coefficient of thermal expansion proximate to the coefficient of thermal expansion of the glass is applied as the metal material of the skirt part 3, and Fe-18Cr steel, Fe-42Ni-6Cr steel, pure Ti or a like material on the surface of which a dense oxide film of a high adhesive property is formed is used as the material.

The skirt part 3 may be formed entirely from such a material having a low coefficient of thermal expansion as mentioned above or may be formed partly from the material mentioned such that only a bonded portion thereof to glass is formed from the material having a low coefficient of thermal expansion while the other portion is formed from a steel plate for working or the like which is used popularly. The connection between the skirt part 3 and the panel 1 may be established using the frit glass 2 described above or alternatively by embedding an end portion of the skirt part 3 directly into the peripheral edge of the panel 1.

In the cathode ray tube of FIGS. 1 and 2, two ribs 31 each in the form of a flange are provided on a body portion of the skirt part 3 made of metal in order to raise the strength of the skirt part 3 itself and reduce the stress at the bonded portion of the skirt part 3 to the panel 1 made of glass. In particular, where the ribs 31 are provided on the skirt part 3, the difference between the rigidity of the skirt part 3 and the rigidity of the panel 1 becomes small. Consequently, moderation of the stress at the bonding portion between the skirt part 3 and the panel 1 at which the stress is likely to be concentrated when the inside of the vacuum vessel formed from the panel 1 and the funnel 4 is brought into a vacuum state can be achieved.

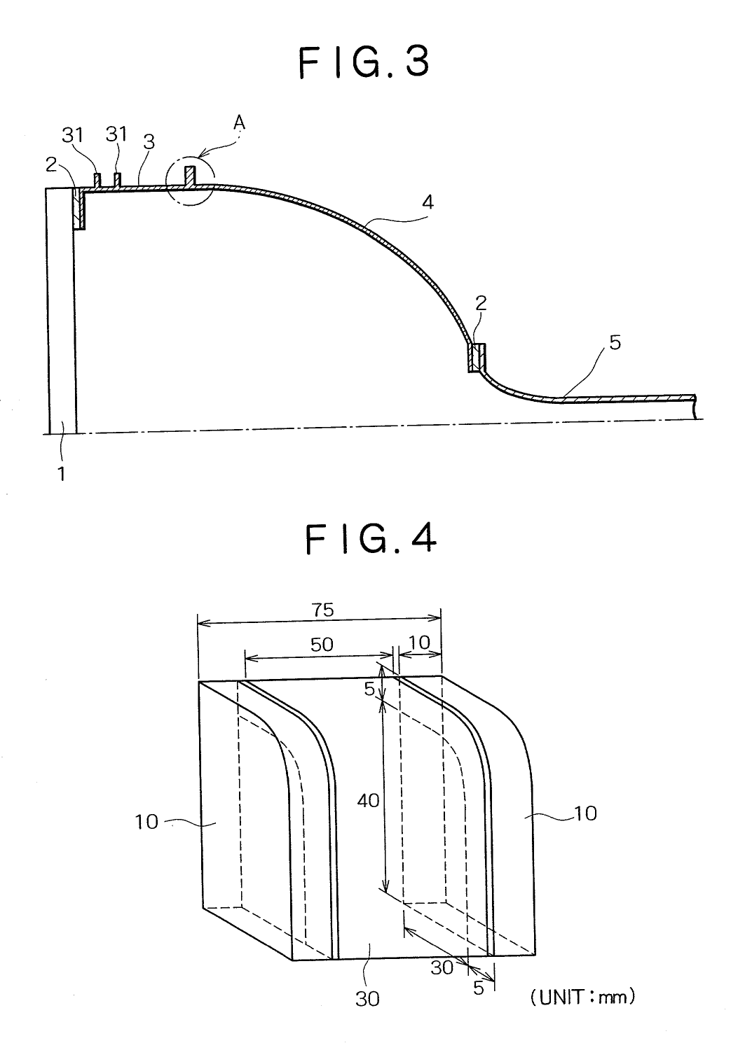

FIG. 3 shows a cathode ray tube wherein metal is used for the funnel. Referring to FIG. 3, the panel 1 and the skirt part 3 are connected to each other through the frit glass 2, and the skirt part 3 and the funnel 4 are welded to each other at a portion indicated by an arrow mark A in FIG. 3. Further, the funnel 4 and a glass cone neck 5 are connected to each other through frit glass 2.

In the cathode ray tube having such a configuration as described above, in order to find out such conditions which make the shape of the ribs 31 provided on the skirt part 3 and the attached positions of the ribs 31 optimum, a stress distribution and a displacement when a pressure of 1 atm is applied to a three-dimensional vacuum vessel model formed from glass and metal are calculated through a three-dimensional stress analysis based on the finite element method.

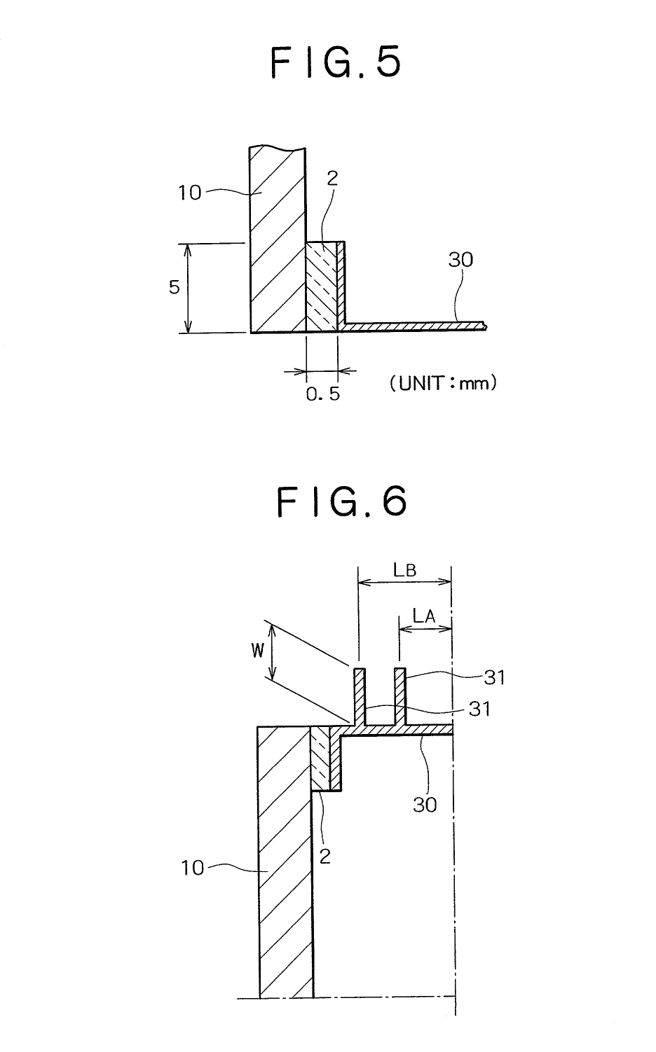

FIG. 4 shows a three-dimensional vacuum vessel model applied in the three-dimensional stress analysis together with several dimensions, and FIG. 5 illustrates several dimensions of a bonding portion in the three-dimensional vacuum vessel model. The three-dimensional vacuum vessel model has a configuration wherein a tubular metal member 30 is bonded to flat glass plates 10. The three-dimensional vacuum vessel model is a vacuum vessel of a component of a cathode ray tube modeled for calculation in a state wherein a skirt part made of a metal material is bonded to a panel made of glass. It is to be noted that the dimensions of different portions of the model are such as illustrated in FIGS. 4 and 5.

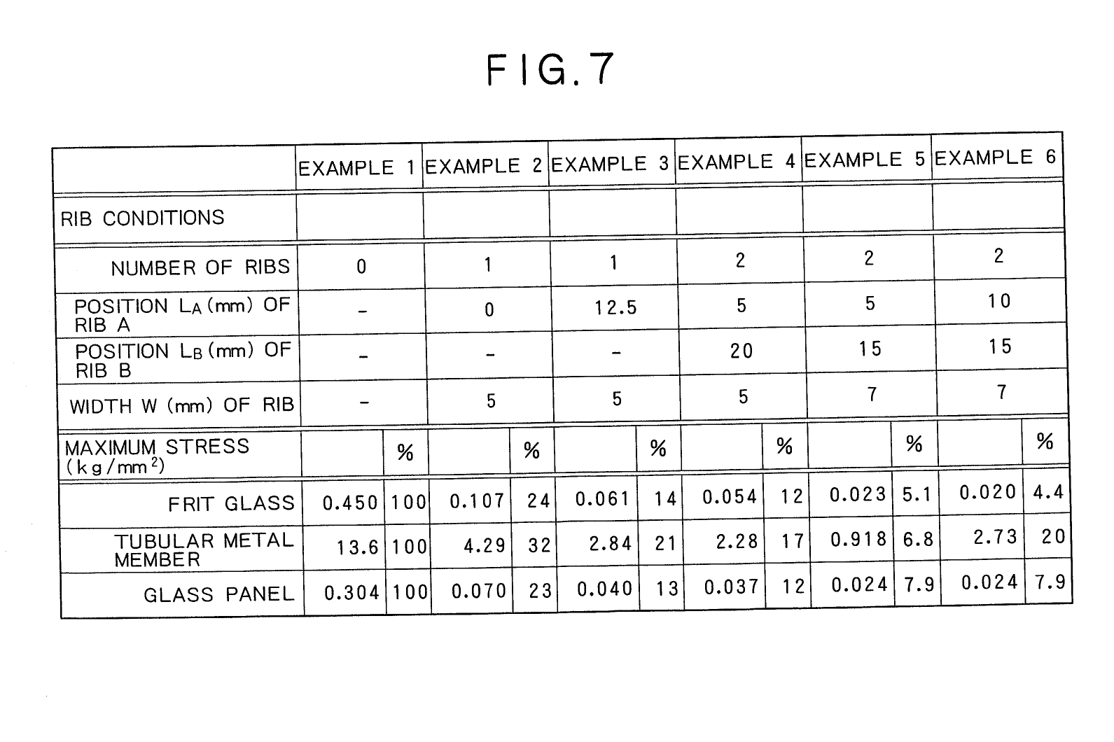

Referring to FIG. 6, the vacuum vessel of the model is composed of a flat glass plate 10, and a tubular metal member 30 and ribs 31 of Fe-18Cr steel, the tubular metal member 30 and the flat glass plate 10 are bonded to each other by the frit glass 2 along a face of a flange attached to an end of the tubular metal member 30. The ribs 31 are attached to the body portion of the tubular metal member 30, and various examples wherein the number, positions and width of such ribs 31 are varied as conditions were produced. FIG. 7 illustrates such rib conditions and stress analysis results of the examples. It is to be noted that reference characters appearing in FIG. 7 correspond to reference characters representative of the dimensions of different portions shown in FIG. 6.

Example 1 is a model wherein the ribs 31 are not attached to the tubular metal member 30. On the other hand, Examples 2 to 6 are models wherein a rib or ribs 31 are attached to the tubular metal member 30. In Examples 2 to 6, a rib or ribs 31 each in the form of a flange are attached in parallel to the bonded face of the tubular metal member 30 to the flat glass plate 10.

Comparison between Example 1 wherein no ribs 31 are attached and Examples 2 to 6 wherein a rib or ribs 31 are attached reveals that a reduction effect of the stress at the different portions arising from attachment of a rib or ribs 31 can be recognized in all of the latter cases.

In a vacuum vessel for which metal and glass are used, the metal/glass bonding portion is the less strongest portion because \mathring{1} it is a place at which discontinuity of the Young's modulus appears and \mathring{2} it is a place at which a bonding material which has a comparatively low strength such as frit glass is used. Accordingly, the number and the positions of ribs with which the stress produced at frit glass at each bonding portion can be reduced effectively provide a preferred embodiment of the present invention.

The stress reduction can be achieved most effectively with Example 6 shown in FIG. 7. In particular, the stress reduction can be achieved most effectively where the number of ribs 31 is rather great and the ribs 31 are positioned such that the rib A is provided at a distance of 10 mm from the center (indicated by an alternate long and short dash line substantially parallel to the flat glass plate 10 in FIG. 6) of the tubular metal member 30 while the rib B is provided at another distance of 15 mm from the center of the tubular metal member 30.

From the results of calculation, in order to achieve a sufficient stress reduction effect at the bonding portion, the ribs A and B should be attached to the flat glass plates 10 at positions spaced from the bonding end and the center of the tubular metal member 30, respectively, by a distance greater by more than 40% the length from the bonding end to the center between the bonding end and the center. Further, the width W of each rib is preferably made as great as possible.

In Example 6 which presents the optimum rib conditions, when compared with Example 1 wherein no rib is provided, the stress can be reduced to 4.4% at the frit glass portion, to 20.0% at the tubular metal member and to 7.9% at the panel glass part.

Where a cathode ray tube wherein ribs are formed in such conditions as described above is used for a display apparatus, the weight of the apparatus can be reduced. Particularly where the display section has an increasing great size, increase of the weight of the apparatus can be suppressed.

Further, since the skirt part 3 made of metal is attached to the peripheral edge of the panel 1, when fluorescent stripes and so forth are to be formed on the inner face of the panel 1, a color selection mechanism can be attached to the skirt part 3 to perform photo-lithography. Thus, even in production of a cathode ray tube for which glass and metal are used, the inner face structure of the panel 1 can be processed by a same production process as that used conventionally.

Further, where a metal member which forms a vacuum vessel for a cathode ray tube is used also as a magnetic shield member used in the existing state of things, such a magnetic shield member as just mentioned can be eliminated, and consequently, further reduction in weight can be achieved. Besides, the metal member can raise the magnetic shielding property and suppress a color drift on the cathode ray tube (display apparatus) caused by magnetism thereby to improve the picture quality.

While a preferred embodiment of the present invention has been described using specific terms, such description is for illustrative purposes only, and it is to be understood that changes and variations may be made without departing from the spirit or scope of the following claims.

What is claimed is:

1. A cathode ray tube, comprising:
a panel made of glass;
a skirt element made of metal and attached to a peripheral edge of said panel; and
a funnel connected to said skirt element;
said skirt element having a rib or ribs for reinforcement provided thereon.

2. A cathode ray tube according to claim 1, wherein said panel extends in a substantially flat plane.

3. A cathode ray tube according to claim 1, wherein said funnel is made of metal.

4. A cathode ray tube according to claim 1, wherein said skirt element has at least two ribs provided thereon.

5. A cathode ray tube according to claim 1, wherein said skirt element has two ribs provided thereon between a bonded end thereof at which said skirt element is bonded to said panel and the center thereof, said two ribs being positioned in a spaced relationship by more than 40% the length from the bonded end to the center of said skirt element individually from the bonded end and the center of said skirt element.

6. A display apparatus, comprising:
a cathode ray tube including a panel made of glass, a skirt element made of metal and attached to a peripheral edge of said panel, and a funnel connected to said skirt element, said skirt element having a rib or ribs for reinforcement provided thereon.
